(19) United States
(12) Patent Application Publication
(10) Pub. No.: US 2005/0083277 A1
(43) Pub. Date: Apr. 21, 2005

(54) Image degradation correction in novel liquid crystal displays with split blue subpixels

(76) Inventor: Thomas Lloyd Credelle, Morgan Hill, CA (US)

Correspondence Address: CLAIRVOYANTE, INC., 874 GRAVENSTEIN HIGHWAY SOUTH, SUITE 14, SEBASTOPOL, CA, 95472, US

(21) Appl. No.: 10/696,236

(22) Filed: Oct. 28, 2003

Related U.S. Application Data
(63) Continuation-in-part of application No. 10/456,839, filed on Jun. 6, 2003.

(51) Int. Cl. G09G 3/36

(52) U.S. Cl. 345/87

(57) ABSTRACT

Systems and methods are disclosed to correct for image degraded signals on a liquid crystal display panel are disclosed. Panels that comprise a subpixel repeating group having an even number of subpixels in a first direction may have parasitic capacitance and other signal errors due to imperfect dot inversion schemes thereon. Techniques for signal correction and localizing of errors onto particular subpixels are disclosed.

### RELATED APPLICATIONS

The present invention is a continuation-in-part application of U.S. patent application Ser. No. 10/456,839 entitled “IMAGE DEGRADATION CORRECTION IN NOVEL LIQUID CRYSTAL DISPLAYS” filed on Jun. 6, 2003, herein incorporated by reference in its entirety, and claims benefit of the priority date thereof.

The present application is related to commonly owned United States patent applications: (1) U.S. patent application Ser. No. 10/455,925 entitled “DISPLAY PANEL HAVING CROSSOVER CONNECTIONS EFFECTING DOT INVERSION”, filed on Jun. 6, 2003; (2) U.S. patent application Ser. No. 10/455,931 entitled “SYSTEM AND METHOD OF PERFORMING DOT INVERSION WITH STANDARD DRIVERS AND BACKPLANE ON NOVEL DISPLAY PANEL LAYOUTS”, filed on Jun. 6, 2003; (3) U.S. patent application Ser. No. 10/455,927 entitled “SYSTEM AND METHOD FOR COMPENSATING FOR VISUAL EFFECTS UPON PANELS HAVING FIXED PATTERN NOISE WITH REDUCED QUANTIZATION ERROR”, filed on Jun. 6, 2003; (4) U.S. patent application Ser. No. 10/456,806 entitled “DOT INVERSION ON NOVEL DISPLAY PANEL LAYOUTS WITH EXTRA DRIVERS”, filed on Jun. 6, 2003; and (5) U.S. patent application Ser. No. 10/456,838 entitled “LIQUID CRYSTAL DISPLAY BACKPLANE LAYOUTS AND ADDRESSING FOR NON-STANDARD SUBPIXEL ARRANGEMENTS,” which are hereby incorporated herein by reference in their entirety.

### BACKGROUND

In commonly owned United States patent applications: (1) U.S. patent application Ser. No. 09/916,232 (“the '232 application”), entitled “ARRANGEMENT OF COLOR PIXELS FOR FULL COLOR IMAGING DEVICES WITH SIMPLIFIED ADDRESSING,” filed Jul. 25, 2001; (2) U.S. patent application Ser. No. 10/278,353 (“the '353 application”), entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed Oct. 22, 2002; (3) U.S. patent application Ser. No. 10/278,352 (“the '352 application”), entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUB-PIXELS,” filed Oct. 22, 2002; (4) U.S. patent application Ser. No. 10/243,094 (“the '094 application), entitled “IMPROVED FOUR COLOR ARRANGEMENTS AND EMITTERS FOR SUB-PIXEL RENDERING,” filed Sep. 13, 2002; (5) U.S. patent application Ser. No. 10/278,328 (“the '328 application”), entitled “IMPROVEMENTS TO COLOR FLAT PANEL DISPLAY SUB-PIXEL ARRANGEMENTS AND LAYOUTS WITH REDUCED BLUE LUMINANCE WELL VISIBILITY,” filed Oct. 22, 2002; (6) U.S. patent application Ser. No. 10/278,393 (“the '393 application”), entitled “COLOR DISPLAY HAVING HORIZONTAL SUB-PIXEL ARRANGEMENTS AND LAYOUTS,” filed Oct. 22, 2002; (7) U.S. patent application Ser. No. 01/347,001 (“the '001 application”) entitled “IMPROVED SUB-PIXEL ARRANGEMENTS FOR STRIPED DISPLAYS AND METHODS AND SYSTEMS FOR SUB-PIXEL RENDERING SAME,” filed Jan. 16, 2003, each of which is herein incorporated by reference in its entirety, novel sub-pixel arrangements are disclosed for improving the cost/performance curves for image display devices.

These improvements are particularly pronounced when coupled with sub-pixel rendering (SPR) systems and methods further disclosed in those applications and in commonly owned United States patent applications: (1) U.S. patent application Ser. No. 10/051,612 (“the '612 application”), entitled “CONVERSION OF RGB PIXEL FORMAT DATA TO PENTILE MATRIX SUB-PIXEL DATA FORMAT,” filed Jan. 16, 2002; (2) U.S. patent application Ser. No. 10/150,355 (“the '355 application”), entitled “METHODS AND SYSTEMS FOR SUB-PIXEL RENDERING WITH GAMMA ADJUSTMENT,” filed May 17, 2002; (3) U.S. patent application Ser. No. 10/215,843 (“the '843 application”), entitled “METHODS AND SYSTEMS FOR SUB-PIXEL RENDERING WITH ADAPTIVE FILTERING,” filed Aug. 8, 2002; (4) U.S. patent application Ser. No. 10/379,767 entitled “SYSTEMS AND METHODS FOR TEMPORAL SUB-PIXEL RENDERING OF IMAGE DATA” filed Mar. 4, 2003; (5) U.S. patent application Ser. No. 10/379,765 entitled “SYSTEMS AND METHODS FOR MOTION ADAPTIVE FILTERING,” filed Mar. 4, 2003; (6) U.S. patent application Ser. No. 10/379,766 entitled “SUB-PIXEL RENDERING SYSTEM AND METHOD FOR IMPROVED DISPLAY VIEWING ANGLES” filed Mar. 4, 2003; (7) U.S. patent application Ser. No. 10/409,413 entitled “IMAGE DATA SET WITH EMBEDDED PRE-SUBPIXEL RENDERED IMAGE” filed Apr. 7, 2003, which are hereby incorporated herein by reference in their entirety.

### BRIEF DESCRIPTION OF THE DRAWINGS

The accompanying drawings, which are incorporated in, and constitute a part of this specification, illustrate exemplary implementations and embodiments of the invention and, together with the description, serve to explain principles of the invention.

FIG. 1A shows a conventional RGB stripe panel having a 1×1 dot inversion scheme.

FIG. 1B shows a conventional RGB stripe panel having a 1×2 dot inversion scheme.

FIG. 2 shows a panel having a novel subpixel repeating group with an even number of pixels in a first (row) direction.

FIG. 3 depicts a panel having the repeating grouping of FIG. 2 with multiple standard driver chips wherein any degradation of the image is placed onto the blue subpixels.

FIG. 4 depicts the phase relationships for the multiple driver chips of FIG. 3.

FIG. 5 depicts a panel having the subpixel repeating group of FIG. 2 wherein the driver chip driving the panel is a 4-phase chip wherein any degradation of the image is placed onto the blue subpixels.

FIG. 6 depicts a panel having a subpixel repeating group having two narrow columns of blue subpixels wherein substantially all or most of the degradation of the image is placed onto the narrow blue subpixel columns.

### DETAILED DESCRIPTION

Reference will now be made in detail to implementations and embodiments, examples of which are illustrated in the accompanying drawings. Wherever possible, the same reference numbers will be used throughout the drawings to refer to the same or like parts.

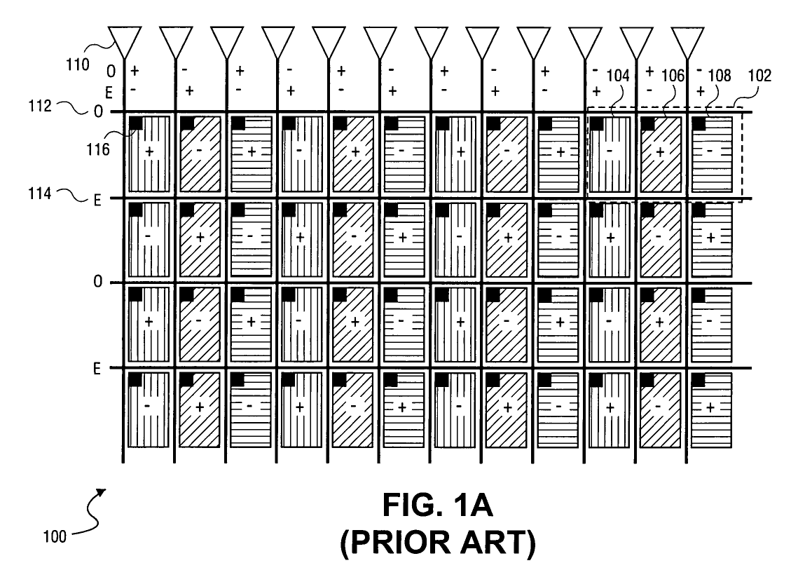

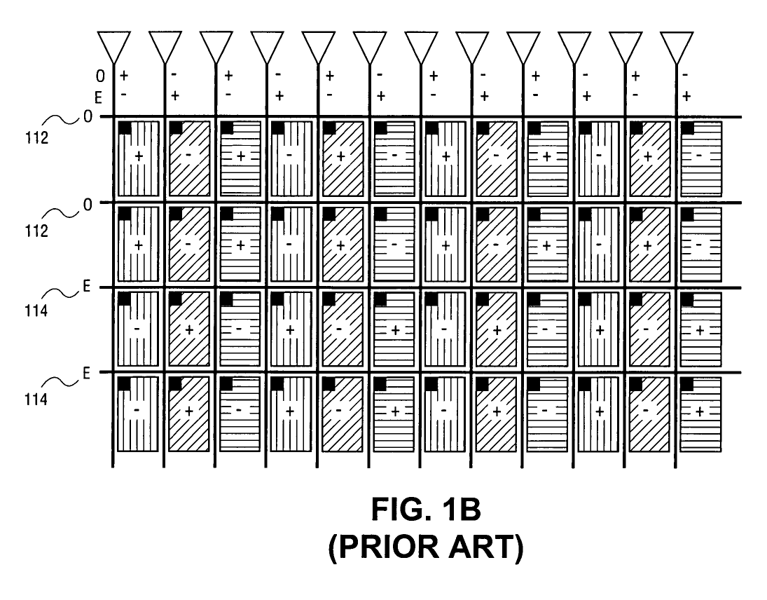

FIG. 1A shows a conventional RGB stripe structure on panel 100 for an Active Matrix Liquid Crystal Display (AMLCD) having thin film transistors (TFTs) 116 to activate individual colored subpixels—red 104, green 106 and blue 108 subpixels respectively. As may be seen, a red, a green and a blue subpixel form a repeating group of subpixels 102 that comprise the panel.

As also shown, each subpixel is connected to a column line (each driven by a column driver 110) and a row line (e.g. 112 and 114). In the field of AMLCD panels, it is known to drive the panel with a dot inversion scheme to reduce crosstalk or flicker. FIG. 1A depicts one particular dot inversion scheme—i.e. 1×1 dot inversion—that is indicated by a “+” and a “−” polarity given in the center of each subpixel. Each row line is typically connected to a gate (not shown in FIG. 1A) of TFT 116. Image data—delivered via the column lines—are typically connected to the source of each TFT. Image data is written to the panel a row at a time and is given a polarity bias scheme as indicated herein as either ODD (“O”) or EVEN (“E”) schemes. As shown, row 112 is being written with ODD polarity scheme at a given time while row 114 is being written with EVEN polarity scheme at a next time. The polarities alternate ODD and EVEN schemes a row at a time in this 1×1 dot inversion scheme.

FIG. 1B depicts another conventional RGB stripe panel having another dot inversion scheme—i.e. 1×2 dot inversion. Here, the polarity scheme changes over the course of two rows—as opposed to every row, as in 1×1 dot inversion. In both dot inversion schemes, a few observations are noted: (1) in 1×1 dot inversion, every two physically adjacent subpixels (in both the horizontal and vertical direction) are of different polarity; (2) in 1×2 dot inversion, every two physically adjacent subpixels in the horizontal direction are of different polarity; (3) across any given row, each successive colored subpixel has an opposite polarity to its neighbor. Thus, for example, two successive red subpixels along a row will be either (+,−) or (−,+). Of course, in 1×1 dot inversion, two successive red subpixels along a column will have opposite polarity; whereas in 1×2 dot inversion, each group of two successive red subpixels will have opposite polarity. This changing of polarity decreases noticeable visual effects that occur with particular images rendered upon an AMLCD panel.

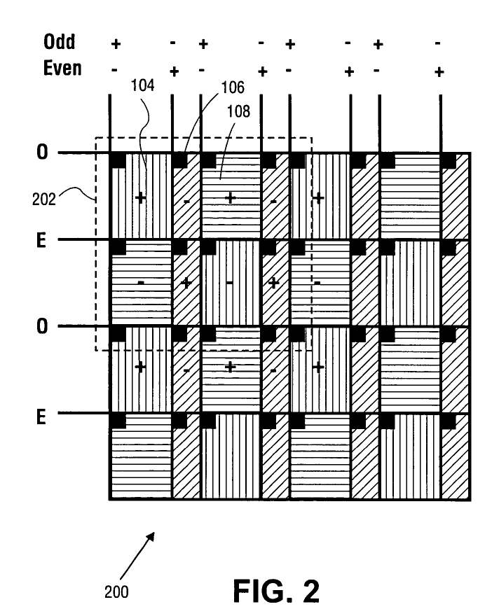

FIG. 2 shows a panel comprising a repeat subpixel grouping 202, as further described in the '353 application. As may be seen, repeat subpixel grouping 202 is an eight subpixel repeat group, comprising a checkerboard of red and blue subpixels with two columns of reduced-area green subpixels in between. If the standard 1×1 dot inversion scheme is applied to a panel comprising such a repeat grouping (as shown in FIG. 2), then it becomes apparent that the property described above for RGB striped panels (namely, that successive colored pixels in a row and/or column have different polarities) is now violated. This condition may cause a number of visual defects noticed on the panel—particularly when certain image patterns are displayed. This observation also occurs with other novel subpixel repeat grouping—for example, the subpixel repeat grouping in FIG. 1 of the '352 application—and other groupings that are not an odd number of repeating subpixels across a row. Thus, as the traditional RGB striped panels have three such repeating subpixels in its repeat group (namely, R, G and B), these traditional panels do not necessarily violate the above noted conditions. However, the repeat grouping of FIG. 2 in the present application has four (i.e. an even number) of subpixels in its repeat group across a row (e.g. R, G, B, and G). It will be appreciated that the embodiments described herein are equally applicable to all such even modulus repeat groupings.

To prevent visual degradation and other problems within AMLCDs, not only must the polarity of data line transitions be randomized along each select line, but the polarity of data line transitions must also be randomized also for each color and locality within the display. While this randomization occurs naturally with RGB triplet color sub-pixels in combination with commonly-used alternate column-inversion data driver systems, this is harder to accomplish when an even-number of sub-pixels are employed along row lines.

In one even modulo design embodiment, rows are formed from a combination of smaller green pixels and less-numerous-but-larger red and blue pixels. Normally, the polarity of data line transitions is reversed on alternate data lines so that each pixel is capacitively coupled about equally to the data lines on either side of it. This way, these capacitor-induced transient errors are about equal and opposite and tend to cancel one another out on the pixel itself. However in this case, the polarity of same-color subpixels is the same and image degradation can occur.

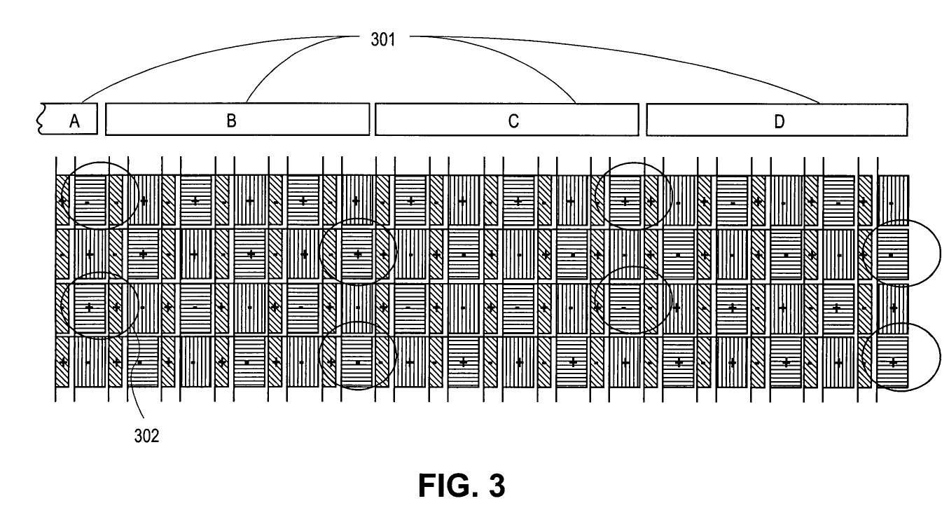

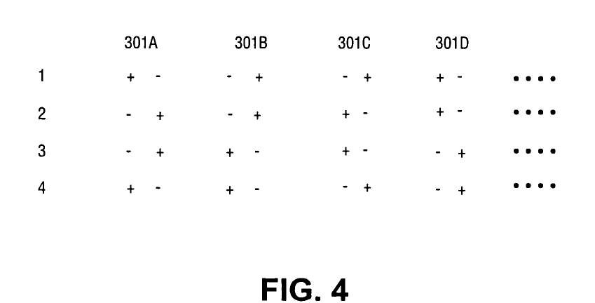

FIG. 3 shows an even modulo pixel layout which utilizes 2×1 dot inversion. Vertical image degradation is eliminated since same color pixels alternate in polarity. Horizontal image degradation due to same-color pixels is reduced by changing the phase of the dot inversion periodically. Driver chips 301A through D provide data to the display; the driver outputs are driven +,−,+,−, . . . or −,+,−,+, . . . The phasing of the polarity is shown in FIG. 4 for the first 4 lines of the display. For example, the first column of chip 301B has the phase −,−,+,+, . . . .

In one embodiment, a subpixel—bordered on either side by column lines driving the same polarity at a given time—may suffer a decreased luminance for any given image signal. So, two goals are to reduce the number of effected subpixels—and to reduce the image degradation effects of any particular subpixel that cannot avoid having been so impacted. Several techniques in this application and in other related applications incorporated herein are designed to minimize both the number and the effects of image degraded subpixels.

One such technique is to choose which subpixels are to be degraded, if degradation may not be avoided. In FIG. 3, the phasing is designed so as to localize the same-polarity occurrence on the circled blue subpixels 302. In this manner, the polarity of same color subpixels along a row is inverted every two driver chips, which will minimize or eliminate the horizontal image degradation. The periodic circled blue subpixels 302 will be slightly darker (i.e for normally-black LCD) or lighter (i.e. for normally-white LCD) than other blue subpixels in the array, but since the eye is not as sensitive to blue luminance changes, the difference should be substantially less visible.

Yet another technique is to add a correction signal to any effected subpixels. If it is known which subpixels are going to have image degradation, then it is possible to add a correction signal to the image data signal. For example, most of the parasitic capacitance mentioned in this and other applications tend to lower the amount of luminance for effected subpixels. It is possible to heuristically or empirically determine (e.g. by testing patterns on particular panels) the performance characteristics of subpixels upon the panel and add back a signal to correct for the degradation. In particular to FIG. 3, if it is desired to correct the small error on the circled pixels, then a correction term can be added to the data for the circled blue subpixels.

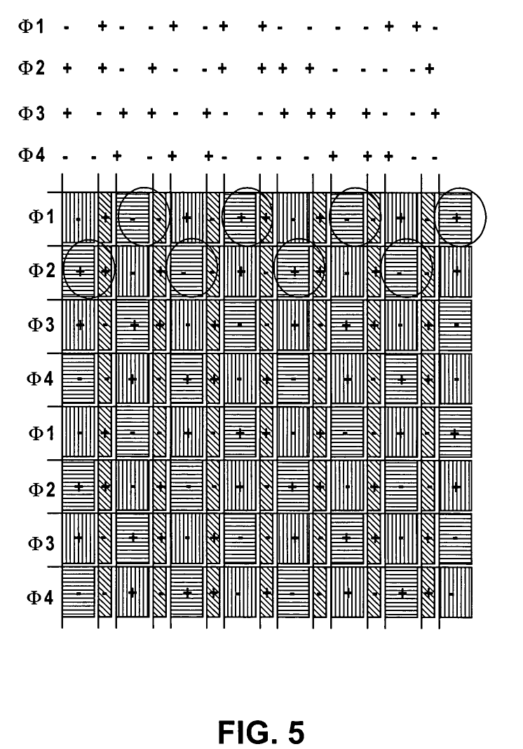

In yet another embodiment of the present invention, it is possible to design different driver chips that will further abate the effects of image degradation. As shown in FIG. 5, a four-phase clock, for example, is used for polarity inversion. By the use of this pattern, or patterns similar, only the blue subpixels in the array will have the same-polarity degradation. However, since all pixels are equally degraded, it will be substantially less visible to the human eye. If desired, a correction signal can be applied to compensate for the darker or lighter blue subpixels.

These drive waveforms can be generated with a data driver chip that provides for a more complex power-supply switching system than employed in the relatively simple alternate polarity reversal designs. In this two-stage data driver design, the analog signals are generated as they are done now in the first stage. However, the polarity-switching stage is driven with its own cross-connection matrix in the second stage of the data driver to provide the more complex polarity inversions indicated.

Yet another embodiment of the techniques described herein is to localize the image degradation effect on a subset of blue subpixels across the panel in both the row and column directions. For example, a “checkerboard” of blue subpixels (i.e. skipping every other blue subpixel in either the row and/or column direction) might be used to localize the image degradation signal. As noted above, the human eye—with its decreased sensitivity in blue color spatial resolution—will be less likely to notice the error. It will be appreciated that other subsets of blue subpixels could be chosen to localize the error. Additionally, a different driver chip with four or fewer phases might be possible to drive such a panel.

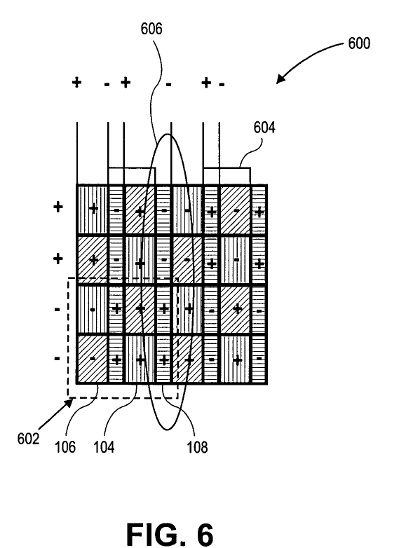

FIG. 6 is yet another embodiment of a panel 600 comprised substantially of a subpixel repeating group 602 of even modulo. In this case, group 602 is comprised of a checkerboard of red 104 and green 106 subpixels interspersed with two columns of blue 108 subpixels. As noted, it is possible (but not mandatory) to have the blue subpixels of smaller width than the red or the green subpixels. As may be seen, two neighboring columns of blue subpixels may share a same column driver through an interconnect 604, possibly with the TFTs of the blue subpixels appropriately remapped to avoid exact data value sharing.

With standard column drivers performing 2×1 dot inversion, it can be seen that blue subpixel column 606 has the same polarity as the column of red and green subpixels to its immediate right. Although this may induce image degradation (which may be compensated for with some correction signal), it is advantageous that the degradation is localized on the dark colored (e.g. blue) subpixel column; and, hence, less visible to the human eye.

1. A liquid crystal display comprising:
a panel substantially comprising a subpixel repeating group comprising an even number of subpixels in a row, said subpixel repeating group further comprising a column of dark colored subpixels; and
a driver circuit sending image data and polarity signals to the panel;
wherein any image degradation in the said signals is localized on said column of dark colored subpixels.

2. The liquid crystal display of claim 1 wherein the dark colored subpixels are blue colored subpixels.

3. The liquid crystal display of claim 1 wherein said subpixel repeating group substantially comprises a checkerboard of red and green subpixels interspersed with two columns of blue subpixels.

4. The liquid crystal display of claim 3 wherein said two columns of blue subpixels share a same column driver.

5. The liquid crystal display of claim 1, wherein one or more subpixels receive a correction signal.

6. A liquid crystal display comprising:
a panel substantially comprising a subpixel repeating group comprising an even number of subpixels in a row wherein said group further comprises a column of blue subpixels; and
a driver circuit having at least two phases, the driver circuit sending image data and polarity signals to said panel, wherein phases of the driver circuits are selected such that any parasitic effects placed upon any subpixels are placed substantially upon said column of blue subpixels.

7. The liquid crystal display of claim 6, wherein a correction signal is sent to one or more subpixels.

8. A method of correcting for image degradation in liquid crystal displays, comprising:
arranging subpixels in a subpixel repeating group of a panel comprising an even number of subpixels in a row, said subpixel repeating group further comprising a column of dark colored subpixels; and
providing driver signals to the subpixels in the panel to send image data and polarity signals such that image degradation in the driver signals is localized on the column of dark colored subpixels.

9. The method of claim 8, wherein the column of dark colored subpixels is a column of blue subpixels.

10. The method of claim 8, wherein arranging subpixels in a subpixel repeating group comprises forming a checkerboard of read and green subpixels interspersed with two columns of blue subpixels.

11. The method of claim 10, wherein providing driver signals includes providing signals to the two columns of blue subpixels from the same column driver.

12. The method of claim 8, further comprising:
providing correction signals to one or more subpixels in the group of subpixels.

13. A method of correcting for image degradation in liquid crystal displays, comprising:
arranging subpixels into at least one subpixel repeating group in a panel, the subpixel repeating group comprising an even number of subpixels in a row and at least one column of blue subpixels; and
providing signals for image data and polarity data to the panel with a driver circuit having at least two phases selected such that any parasitic effects placed upon any subpixels are placed substantially upon the at least one column of blue subpixels.

14. The method of claim 13, further comprising providing a correction signal to one or more subpixels.

15. A liquid crystal display, comprising:
means for arranging subpixels in a subpixel repeating group of a panel comprising an even number of subpixels in a row, said subpixel repeating group further comprising a column of dark colored subpixels; and
means for providing driver signals to the subpixels in the panel to send image data and polarity signals such that image degradation in the driver signals is localized on the column of dark colored subpixels.

16. The liquid crystal display of claim 15, wherein the column of dark colored subpixels is a column of blue subpixels.

17. The liquid crystal display of claim 15, wherein the means for arranging subpixels in a subpixel repeating group comprises means for forming a checkerboard of read and green subpixels interspersed with two columns of blue subpixels.

18. The liquid crystal display of claim 17, wherein means for providing driver signals includes means for providing signals to the two columns of blue subpixels from the same column driver.

19. The liquid crystal display of claim 15, further comprising:
means for providing correction signals to one or more subpixels in the group of subpixels.

20. A liquid crystal display, comprising:
means for arranging subpixels into at least one subpixel repeating group in a panel, the subpixel repeating group comprising an even number of subpixels in a row and at least one column of blue subpixels; and
means for providing signals for image data and polarity data to the panel with a driver circuit having at least two phases selected such that any parasitic effects placed upon any subpixels are placed substantially upon the at least one column of blue subpixels.

21. The liquid crystal display of claim 20, further comprising providing a correction signal to one or more subpixels.
